(19) United States
(12) Patent Application Publication
(10) Pub. No.: US 2018/0268421 A1
(43) Pub. Date: Sep. 20, 2018

(54) METHOD OF PRINTING PRODUCT CODE WITH A MODIFIED CHARACTER

(71) Applicant: The Procter & Gamble Company, Cincinnati, OH (US)

(72) Inventors: Jonathan Richard Stonehouse, Windlesham (GB); Grant Robert Meadows, Mortimer (GB)

(21) Appl. No.: 15/902,258

(22) Filed: Feb. 22, 2018

Related U.S. Application Data
(60) Provisional application No. 62/471,980, filed on Mar. 16, 2017.

(51) Int. Cl. G06Q 30/00

(52) U.S. Cl. CPC G06Q 30/018

(57) ABSTRACT

A method of introducing a verification check to a product is provided. The method comprises generating an alphanumeric code associated with the product, using one or more digits in the code to calculate a resultant value and modifying at least one digit in the code based on the resultant value. The resultant value determines the form of modification based on a predetermined selection of possible modifications.

### TECHNICAL FIELD

The present invention relates to a method of printing a verification code for a product, a method of verifying the authenticity of a product and a verification code.

### BACKGROUND

Counterfeit items are a large problem in many industries, particularly in developing countries. They can erode consumer confidence or in extreme cases, cause actual harm, and generate losses for manufacturers and distributors. A variety of methods have been used over the years to allow the verification of the authenticity of items, including holographic labels, RFID tags, and overt and covert codes. Although these methods may provide a way to detect counterfeit items, they also involve additional costs and/or complexity to the production process.

A variety of techniques have recently been proposed that involve manipulation of existing codes and/or information provided on a product for tracking purposes. For example, WO 2012/109294 A1 discloses a method of printing a product code with one or more modified characters. The method uses an existing alphanumeric code that is determined by, for example, the date and location of manufacture, and existing printing technology. An algorithm is applied to digits in the original code (pre-modification), and based on the output of the algorithm, one or more digits in the code are selected and modified in a predetermined manner. For example, the modification may involve removal of a pixel of an individual digit that is barely perceptible to the naked eye, but that provides a clear signal to someone actively seeking to verify the authenticity of the product.

While such techniques are considerably useful in terms of helping manufacturers, retailers and end users to ascertain the authenticity of products, counterfeiters are becoming more sophisticated at interpreting such codes and being able to replicate them. Thus, there exists a need for continual development of new techniques to provide overt and covert verification techniques.

### SUMMARY

According to the present invention, there is provided a method of introducing a verification check to a product, comprising the steps of generating an alphanumeric code associated with the product; modifying at least one digit in the code based on a value derived from one or more digits in the code itself or a different code on the product, packaging, shipper or other surface associated with the product, wherein the resultant value determines the form of modification to the at least one digit.

In the present invention, the digits of the code are used to provide a resultant value that is associated with a particular form of modification, thus introducing additional variation to the form of variation, making it harder for counterfeiters to understand and copy the verification technique. This means that for each individual character that may form part of the code, there will be a number of possible modifications, the selection of which modification is based on the resultant value determined from one or more digits of the code.

In a preferred embodiment, the modification to a digit is based on the value of an adjacent digit. For each digit, a number of alternative modifications are predetermined and associated with different values (e.g., between 0 and 9). Using an algorithm, or simply using the value of an adjacent digit will determine which of the predetermined modifications should be applied.

In an embodiment, the method further comprises predefining a selection of alternative modifications to a single digit based on a numerical value; calculating a resultant value using one or more digits in the code; using the resultant value to select one of the predefined modifications for printing in the code.

Using numbers/letters in the code itself, or a different code on the product, packaging, shipper or other surface associated with the product, to determine the change to one or more digit ensures that the verification method is self-contained provided the algorithm/recipe to generate the predetermined value is known. Thus, from the product, packaging and/or other surfaces associated with the product, it would be possible for someone to verify the authenticity of a product. Furthermore, the different modifications would be barely perceptible to a counterfeiter and, even if they were perceptible, as the modification varies along with the code, it would be very difficult for counterfeiters to copy the exact code each time.

Preferably, the resultant value is the sum, or other function, of more than one digit in the code. Alternatively, the resultant value may be derived from just one digit (e.g., the digit adjacent that intended for modification). The resultant value may be derived from any alphanumeric character. For example, where the digit is a letter (rather than a number), a number may be designated to that letter (e.g., a=0, b=1 etc).

In the present invention, the digits of the code are used to provide a resultant value that is associated with a particular form of modification, thus introducing additional variation to the algorithm, making it harder for counterfeiters to understand and copy the verification technique. The resultant value may be linked to a modification of a digit that involves, for example, changing the size of a digit, removing a predetermined pixel, adding a feature to the digit etc. Many of the modifications require printers with special fonts that would be difficult and costly for a counterfeiter to reproduce.

Thus, in an embodiment, the modification may include choosing a different font type, where the choice, a digit with a different font type could be chosen with the numerical value determining which font set for the particular digit is used.

In another embodiment, the value can be used to choose a different font size, different colour or to choose whether the digit is italic.

In a preferred embodiment, the modification to a digit, or font set choice, is based on the value of an adjacent digit. For each digit, a number of alternative modifications are predetermined and associated with different values (e.g., between 0 and 9). Using an algorithm, or simply using the value of an adjacent digit will determine which of the predetermined modifications should be applied.

### BRIEF DESCRIPTION OF THE DRAWINGS

While the specification concludes with claims, it is believed that the same will be better understood from the following description taken in conjunction with the accompanying drawings in which:

FIG. 1 shows an example code and demonstrates the recipe/algorithm for choosing the character modification.

FIG. 2 shows possible modifications to a character.

FIG. 3 shows examples of a single value being used to choose a particular pre-defined modified character.

FIG. 4 shows further possible modifications to a character.

FIG. 5 shows ways to assign a value to an alphanumeric digit.

FIG. 6 illustrates an alternative algorithm/recipe for choice of modification.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

A variety of methods have been used to allow the verification of the authenticity of products. The present invention is concerned with modification of one or more characters in a pre-existing code, based on a value derived from one or more characters in the code itself or a different code on the product, packaging, shipper or other surface associated with the product. To simplify the description of the invention, it will be described in terms of using information in the code itself to determine what modifications will be made in the code. However, as noted above and throughout, the information used to modify the code can be obtained from a different code on the product, packaging, shipper or other surface associated with the product. In such instances, all of the information provided herein with regard to modifying a code based on information in the code itself is the same other than where the information is obtained from to modify the code on the product and/or packaging. In addition to modifying the code based on information in a different code, the code may be modified based on information from two or more different codes or from the code itself plus information from one or more different codes.

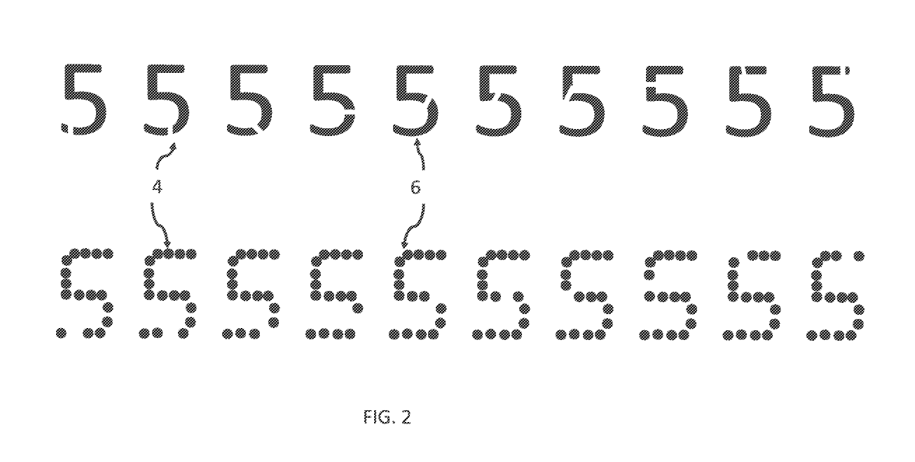

Each potential digit in a code has a selection of pre-defined modifications, associated with a value (typically from 0 to 9). The value derived from the one or more characters in the code is used to determine which modification should be applied to a particular digit. For example, in an embodiment, the modification being made to a digit may be to remove a section. Thus, there may be ten different areas of the digit that could be removed—depending on the value attributed to the different modification, as shown in FIG. 2. It will be appreciated that there may be more or less than ten different modifications according to the algorithm/recipe determined for modifying the code. The number of potential modifications may be based on cost or complexity of the code. For example, it may cost more to provide a printer with multiple choices for each character. Thus, in one embodiment, each character may have just three possible modifications. Alternatively, it may be the case that only 4 or 5 of the possible characters used may be modified in e.g., ten different ways per character. In both cases, there would still be a multitude of possible permutations.

### Article

In the present invention, an article may be any product or packaging that may bear some label to identify the product or pack. Typically, the article will be direct or bulk packaging, or, for example, a pallet upon which multiple packs may be placed and shipped or sold.

The article will typically carry some form of identification code. The identification code may be incorporated in artwork of a product, or may be a separate label that is applied to the article. An “article” may include, but are not limited to, an individual injection or blow molded object for consumer usage, e.g., a shaver, a toothbrush, a battery, or a container suitable for containing compositions. Preferably the article is a container, non-limiting examples of which include a bottle, a bottle, a jar, a cup, a cap, and the like. The term “container” is used to broadly include elements of a container, such as a closure or dispenser of a container. The compositions contained in such a container may be any of a variety of compositions including, but not limited to, detergents (e.g., laundry detergent, fabric softener, dish care, skin and hair care), beverages, powders, paper (e.g., tissues, wipes), beauty care compositions (e.g., cosmetics, lotions), medicinal, oral care (e.g., tooth paste, mouth wash), and the like. The container may be used to store, transport, or dispense compositions contained therein.

It will be appreciated that the present invention is particularly applicable to branded products and goods. A branded product may include any product that has an identifiable source (e.g., manufacturer or provider). Often, but certainly not always, a branded product is marked with a proprietary name or feature, such as a trademark. In some cases, a product brand may be recognizable by the design, shape or colour of a product or good. A branded product may include, but is by no means limited to: pharmaceuticals, cosmetics, toiletries, hair care products, household goods, cleaning products and luxury items.

### Code

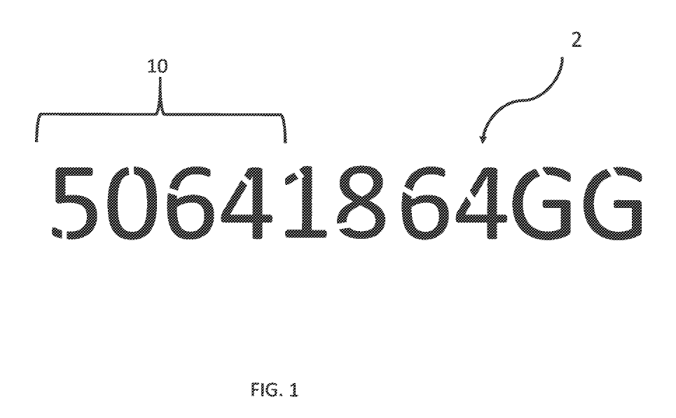

Product codes are known for identification of products and for carrying on, for example, the origin of a product. The product code may be numerical only or alphanumerical and may be based on information such as the date, time or place of manufacture. In an embodiment, the product code may be a string of ten alphanumeric characters consisting of numbers and letters, such as the code 2 shown in FIG. 1. However, it will be appreciated that alternative embodiments of the invention may use a security code that is more or less than ten characters in length, and may use a code that makes use of the entire set of ASCII characters. The product code may also include two or more lines of code.

The code may be applied or printed to the product, label or product packaging with a variety of printers.

### Modified Code

One or more characters in the code will be modified according to a value generated from one or more other characters in the code itself or a different code on the product, packaging, shipper or other surface associated with the product. For each character that may be modified, there will be available a selection of modified versions of that character that are associated to the generated value. For example, if the character “5” is to be modified, a series of alternative forms of “5” will be available and each will correspond to a different value (FIG. 2). For example, where the value generated is 2, the “5” is modified as shown 4. Alternatively, if the value is 5, the “5” is modified as shown 6. Each character used in the code may have a selection of alternative modified versions available such that each character may be modified in a number of different ways, each of which would correspond to a value. Alternatively, select characters may be chosen for modification thus limiting the number of modified characters required. For example, in an embodiment, only numbers 1 to 5 may be modified and each of the numbers may be modified in up to 10 ways. The value determined from the one or more other characters in the code, would determine which of the 10 modifications should be applied. It will be appreciated however that there are endless permutations of how the characters could be modified.

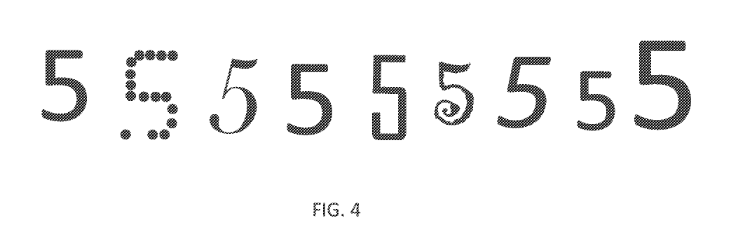

Furthermore, the form of modification may be different. By “modified”, it is meant that the character is different from its original form with some change in appearance that may be designed to be subtle and unlikely to be noticed by a consumer, or more obvious and noticeable. FIGS. 2 and 4 show a non-exhaustive variety of possible modifications to a single digit. The modified character may have something added to it, or is of a different font, a different size or a different colour to the standard character (FIG. 4).

### Algorithm

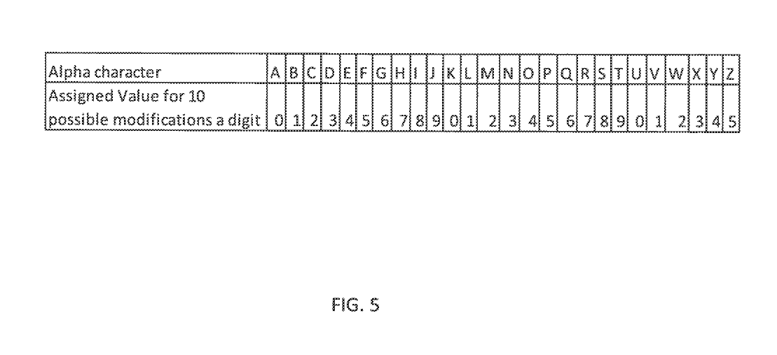

FIG. 2 shows multiple variations of the same character. The choice of which variation to use may be based on a function of some or all of the characters of the initial product code. The choice of modification may be based on the value of the character immediately adjacent the character to be modified. For example, as shown in FIG. 1, taking the four digits “5064” 10 in the code as an example, each digit is modified in a pair, according to the value of the neighboring character e.g. the digit “5” has a “0” as its pair and therefore the 0^{th} modification is chosen for digit “5”. The digit “0” has a “5” as its pair so the 5^{th} modification for the digit “0” is chosen. This methodology may be applied to each digit/letter in the code. Alpha characters can be considered to have their value given by assigning a value to the character (lower and upper case will not be distinguished). If there are 10 possible modifications to each character then the scheme in FIG. 5 could be used to assign the value to the alphanumeric character.

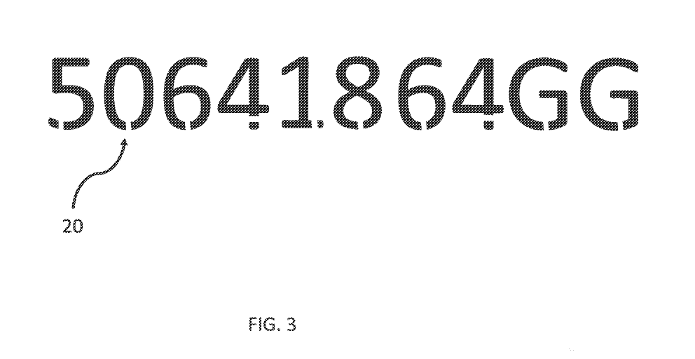

Alternatively, the value used to choose the modification for each specific alphanumeric digit can be the value of any of the other alphanumeric digits in the code. In FIG. 3, the value of the 2^{nd} alphanumeric digit 20 in the code is arbitrarily chosen to define the modification for all digits.

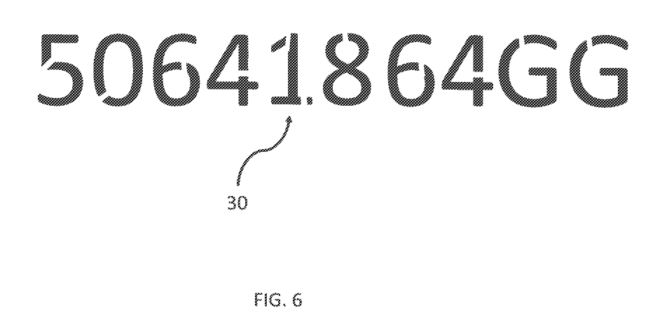

The value can may be based on a mathematical algorithm applied to characters in the code. The algorithm may be calculated by performing a mathematical operation, or series of mathematical operations on the component numbers and/or letters of the printed code. FIG. 6 shows a possible algorithm where the value used to choose the modification is derived by adding the value of the 5^{th} alphanumeric digit 30 to the value of each digit, and using the resultant value to determine the modification.

There are a multitude of different algorithms that may be used which will further increase the difficulty for someone to copy the code together with modifications.

### Printer

The printer is controlled to print a product code on a substrate, including continuous ink jet, thermal ink jet, drop on demand, thermal transfer printers, or laser ablation or other laser marking devices, hotmelt wax printers. A further embodiment could be the use of a digital artwork printer to print the code. The substrate may be any desired substrate, including porous and non-porous materials, primary and secondary packaging, and the products themselves, typically consumer products.

### Examples/Combinations

A. A method of introducing a verification check to a product, comprising the steps of:
   a) Generating an alphanumeric code associated with the product;
   b) Calculating a resultant value using one or more digits in the code itself or a different code;
   c) Modifying at least one digit in the code based on the resultant value, wherein the resultant value determines the form of modification to the at least one digit.
B. A method as described in paragraph A, further comprising:
   a) Pre defining a selection of potential modifications to a character, digit or symbol wherein each potential modification corresponds to a numerical value;
   b) Calculating a resultant value using one or more digits in the code or a different code; and
   c) Using the resultant value to select one of the predefined modifications for printing in the code.
C. A method as described in paragraph A, wherein the resultant value may be the sum or other function of more than one digit in the code or a different code.
D. A method as described in paragraph A, wherein the resultant value is determined by a single digit in the code or a different code.
E. A method as described in paragraph D, wherein the resultant value is determined by the digit in the code adjacent the at least one digit.
F. A method as described in paragraph D, wherein the resultant value is determined by any digit in the code selected at random.
G. A method as described in paragraph A, wherein the predefined modification comprises adding to a digit, removing sections of the digit, selecting an alternative font or changing the size or colour of the at least one digit.
H. A method as described in paragraph A, wherein all digits in the code are modified according to an algorithm that determines one or more resultant values based on digits in the code.
I. A verification code for anti-counterfeit purposes, comprising a string of alphanumeric digits associated with a product, wherein at least one digit in the code is modified based on a resultant value determined using one or more digits in the code.
J. A verification code as described in paragraph I, wherein the modification comprises adding to a digit, removing sections of the digit, selecting an alternative font or changing the size or colour of the at least one digit.
K. A verification code as described in paragraph I, wherein all digits in the code are modified based on one or more resultant values determined using one or more digits in the code.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of introducing a verification check to a product, comprising the steps of:
a) generating an alphanumeric code associated with the product;
b) calculating a resultant value using one or more digits in the code;
c) modifying at least one digit in the code based on the resultant value, wherein the resultant value determines the form of modification to the at least one digit.

2. The method of claim 1, further comprising:
d) predefining a selection of potential modifications to a character, digit or symbol wherein each potential modification corresponds to a numerical value;
e) calculating a resultant value using one or more digits in the code; and
f) using the resultant value to select one of the predefined modifications for printing in the code.

3. The method of claim 1, wherein the resultant value may be the sum or other function of more than one digit in the code.

4. The method of claim 1, wherein the resultant value is determined by a single digit in the code.

5. The method of claim 4, wherein the resultant value is determined by the digit adjacent the at least one digit.

6. The method of claim 4, wherein the resultant value is determined by any digit in the code selected at random.

7. The method of claim 1, wherein the predefined modification comprises adding to a digit, removing sections of the digit, selecting an alternative font or changing the size or colour of the at least one digit.

8. The method of claim 1, wherein all digits in the code are modified according to an algorithm that determines one or more resultant values based on digits in the code.

9. A verification code for anti-counterfeit purposes, comprising a string of alphanumeric digits associated with a product, wherein at least one digit in the code is modified based on a resultant value determined using one or more digits in the code.

10. The verification code of claim 9, wherein the modification comprises adding to a digit, removing sections of the digit, selecting an alternative font or changing the size or colour of the at least one digit.

11. The verification code of claim 9, wherein all digits in the code are modified based on one or more resultant values determined using one or more digits in the code.

12. A method of introducing a verification check to a product, comprising the steps of:
generating an alphanumeric code associated with the product;
calculating a resultant value using one or more digits in one or more different codes; and
modifying at least one digit in the code based on the resultant value, wherein the resultant value determines the form of modification to the at least one digit.

13. The method of claim 12, further comprising:
pre defining a selection of potential modifications to a character, digit or symbol wherein each potential modification corresponds to a numerical value;
calculating a resultant value using one or more digits in one or more different codes; and
using the resultant value to select one of the predefined modifications for printing in the code.

14. The method of claim 12, wherein the resultant value may be the sum or other function of more than one digit in the one or more different codes.

15. The method of claim 12, wherein the resultant value is determined by a single digit in the one or more different codes.

16. The method of claim 15, wherein the resultant value is determined by the digit in the code adjacent the at least one digit.

17. The method of claim 15, wherein the resultant value is determined by any digit in the code selected at random.

18. The method of claim 12, wherein the predefined modification comprises adding to a digit, removing sections of the digit, selecting an alternative font or changing the size or colour of the at least one digit.

19. The method of claim 12, wherein all digits in the code are modified according to an algorithm that determines one or more resultant values based on digits in the one or more different codes.

20. A verification code for anti-counterfeit purposes, comprising a string of alphanumeric digits associated with a product, wherein at least one digit in the code is modified based on a resultant value determined using one or more digits in the one or more different codes.

21. The verification code of claim 20, wherein the modification comprises adding to a digit, removing sections of the digit, selecting an alternative font or changing the size or colour of the at least one digit.

22. The verification code of claim 20, wherein all digits in the code are modified based on one or more resultant values determined using one or more digits in the one or more different codes.
